(19) United States
(12) Patent Application Publication
(10) Pub. No.: US 2022/0282672 A1
(43) Pub. Date: Sep. 8, 2022

(54) FIRE PROTECTION STRUCTURE

(71) Applicants: PRATT & WHITNEY CANADA CORP., Longueuil (CA); LA CORPORATION DE L'ÉCOLE POLYTECHNIQUE DE MONTRÉAL, Montreal (CA); ELASTO PROXY INC., Boisbriand (CA)

(72) Inventors: Louis LABERGE LEBEL, Montreal (CA); Pablo de Jesus CHAVEZ GOMEZ, Montreal (CA); Alain RICHER, Repentigny (CA); Etienne ROBERT, Saint-Lambert (CA); Jason HAMP, Georgetown (CA)

(21) Appl. No.: 17/191,154

(22) Filed: Mar. 3, 2021

(51) Int. Cl. F02C 7/25

(52) U.S. Cl. CPC F02C 7/25; F05D 2300/224; F05D 2300/603; F05D 2300/601

(57) ABSTRACT

A fire protection structure to be affixed to a substrate adapted to be exposed to a heat source, has: an expandable layer containing an intumescent material expandable when exposed to the heat source, the expandable layer expandable, when exposed to a temperature above a temperature threshold generated by the heat source, from a first thickness to a second thickness greater than the first thickness; and a compliant textile structure retaining the expandable layer, at least a portion of the expandable layer disposed relative to the compliant textile structure such that the portion of the expandable layer is disposed between the substrate and the compliant textile structure when the fire protection structure is attached to the substrate, the compliant textile structure deformable with expansion of the expandable layer from the first thickness to the second thickness.

### TECHNICAL FIELD

The application relates generally to fire protection and, more particularly, to fire protection structures to protect a substrate against fire.

### BACKGROUND

Fire protection structures have many uses. They may be used, for example only, in garments, kitchen equipment, vehicles, and engines, including but not limited to gas turbine engines. Such fire protection structures may at least partially enclose and/or separate a hot or potential fire zone. In gas turbine engines applications, regulations and standards may require certain regions and/or components to be protected against fire that may start on or near a surface, such as near the combustor and/or turbine section for example.

Consequently, gas turbine engines may be divided in a plurality of zones that operate at respective different temperatures. These zones may be separated from one another by firewalls to prevent any flammable fluid leakage between the zones and to help in limiting a fire to spread from one zone to one or more adjacent zones. These firewalls may be heavy. Some lighter alternatives may be less suited for the aerospace industry. Improvements are therefore sought.

### SUMMARY

In one aspect, there is provided a fire protection structure to be affixed to a substrate adapted to be exposed to a heat source, comprising: an expandable layer containing an intumescent material expandable when exposed to the heat source, the expandable layer expandable, when exposed to a temperature above a temperature threshold generated by the heat source, from a first thickness to a second thickness greater than the first thickness; and a compliant textile structure retaining the expandable layer, at least a portion of the expandable layer disposed relative to the compliant textile structure such that the portion of the expandable layer is disposed between the substrate and the compliant textile structure when the fire protection structure is attached to the substrate, the compliant textile structure deformable with expansion of the expandable layer from the first thickness to the second thickness.

In some embodiments, the compliant textile structure is a knitted structure extensible both in a widthwise direction and a lengthwise direction, both of the widthwise direction and the lengthwise direction parallel to the substrate.

In some embodiments, the expandable layer includes a matrix, the intumescent material including intumescent particles embedded in the matrix.

In some embodiments, the expandable layer includes filler particles embedded in the matrix.

In some embodiments, the intumescent particles are expandable graphite particles, vermiculite, melamine, and/or sodium silicate, and wherein the matrix includes an elastomer.

In some embodiments, the expandable layer and the compliant textile structure are embedded into one another.

In some embodiments, the compliant textile structure is a knitted structure, the knitted structure including yarns knitted together, the knitted structure having open cells between the yarns, the open cells filled with the expandable layer.

In some embodiments, the compliant textile structure is a knitted structure, the expandable layer and the knitted structure are each a respective layer of a layered structure, the expandable layer sandwiched between the knitted structure and the substrate.

In some embodiments, compliant textile structure is a knitted structure including a first yarn and a second yarn, the first yarn defining successive first loops, the second yarn defining successive second loops, each of the first loops received in a respective one of the second loops.

In some embodiments, a fastening layer is connected to the expandable layer for securing the fire protection structure to the substrate, the fastening layer including an adhesive or mechanical fasteners.

In another aspect, there is provided a gas turbine engine, comprising: a first zone and a second zone; a wall between the first zone and the second zone; and a fire protection structure affixed to the wall, the fire protection structure including: an expandable layer containing an intumescent material expandable when exposed to a heat source, the expandable layer expandable, when exposed to a temperature above a temperature threshold generated by the heat source, in a direction normal to the wall from a first thickness to a second thickness greater than the first thickness, and a compliant textile structure retaining the expandable layer, at least a portion of the expandable layer disposed between the wall and the compliant textile structure, the compliant textile structure deformable with expansion of the expandable layer from the first thickness to the second thickness.

In some embodiments, the compliant textile structure is a knitted structure extensible both in a widthwise direction and a lengthwise direction, both of the widthwise direction and the lengthwise direction parallel to the wall.

In some embodiments, the expandable layer includes a matrix, the intumescent material including intumescent particles embedded in the matrix.

In some embodiments, the expandable layer includes filler particles embedded in the matrix.

In some embodiments, the intumescent particles are expandable graphite particles, vermiculite, melamine, and/or sodium silicate, and wherein the matrix includes an elastomer.

In some embodiments, the expandable layer and the compliant textile structure are embedded into one another.

In some embodiments, the compliant textile structure is a knitted structure, the knitted structure including yarns knitted together, the knitted structure having open cells between the yarns, the open cells filled with the expandable layer.

In some embodiments, the compliant textile structure is a knitted structure, the expandable layer and the knitted structure are each a respective layer of a layered structure, the expandable layer sandwiched between the knitted structure and the wall.

In some embodiments, the compliant textile structure is a knitted structure including a first yarn and a second yarn, the first yarn defining successive first loops, the second yarn defining successive second loops, each of the first loops received in a respective one of the second loops.

In some embodiments, the yarns are ceramic yarns.

### BRIEF DESCRIPTION OF THE DRAWINGS

Reference is now made to the accompanying figures in which:

FIG. 1 is a schematic cross sectional view of an exemplary implementation of a fire protection structure in accordance with one embodiment;

FIG. 2 is a schematic cross-sectional view showing a layered structure of the fire protection structure of FIG. 1;

FIG. 3 is a plan view of the fire protection structure of FIG. 2, a portion of which being expanded after being exposed to a heat source;

FIG. 4 is a side view of the fire protection structure of FIG. 3 having the portion expanded after exposure to the heat source;

FIG. 5 is a plan view of a knitted structure to be used into the layered structure of FIG. 2;

FIG. 6 is an enlarged view of a portion of FIG. 5 illustrating engagement between two yarns of the knitted structure of FIG. 5; and

FIG. 7 is a cross-sectional view of another exemplary implementation of the fire protection structure of FIG. 1 in a gas turbine engine.

### DETAILED DESCRIPTION

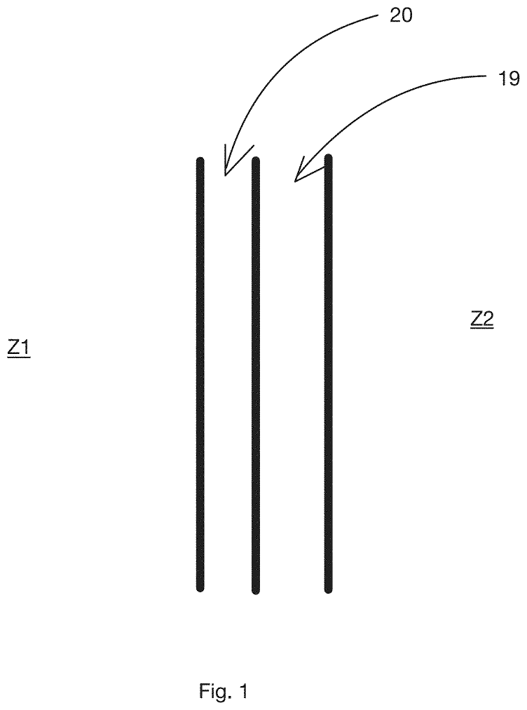

Referring to FIG. 1, an exemplary embodiment of an implementation of a fire protection structure 20 is shown. In the embodiment shown, the fire protection structure 20 is affixed to a wall 19 that separates a fire zone Z1 from a non fire zone Z2. As shown, the fire protection structure 20 is affixed on a side of the wall 19 that faces the fire zone Z1. Alternatively, the fire protection structure 20 may be affixed to a side of the wall 19 that faces the non fire zone Z2. The wall 19 may be any suitable substrate on which the fire protection structure 20 may be affixed. For instance, the substrate may be a fabric of a garment. The fire protection structure 20 may be used for heat and acoustic insulation for engine or other fields (e.g., aerospace industry, construction, etc), for optimisation of fireproofing, for pressurized acoustic sandwich structures, and any other suitable use.

Typical structural fire protection relies either on fireproof or heat blocking materials (i.e. low heat transfer coefficient). In some cases, a combination of both provides a solution that enhances heat blocking. This type of solutions is usually expensive, heavy and/or bulky. The fire protection structure 20 of the present disclosure may allow offer efficient fire protection without the weight penalty of typical structural fire protection.

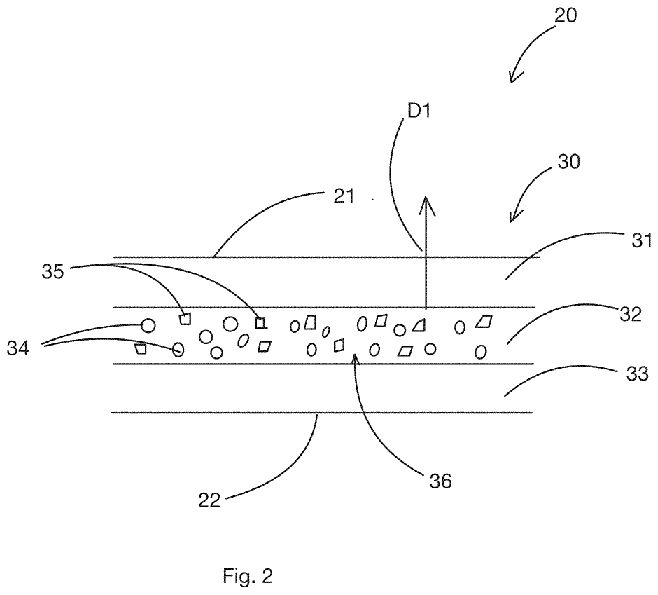

Referring now to FIG. 2, the fire protection structure 20 is shown in cross-section to illustrate a layered structure 30 of the fire protection structure 20. The fire protection structure 20 has a first side 21 facing the fire zone Z1 and an opposed second side 22 affixed to the wall 19 to be protected in case of a fire. The layered structure 30 includes a first layer 31 of flexible and deformable retainer, a second layer 32, which is also referred to as an expandable layer, containing an intumescent material, and a third layer 33, which is also referred to as a fastening layer, containing a binding agent for securing the fire protection structure 20 to the wall to be protected against fire. In some cases, the third layer 33 may be omitted and the fire protection structure 20 may be stitched to a garment, tacked to a wall, and so on. Any suitable mechanical fasteners may be used to affix the fire protection structure 20 to a substrate. The first layer 31 extends from the first side 21 of the fire protection structure 20 toward the second side 22, the third layer 33 extends from the second side 22 of the fire protection structure 20 toward the first side 21, and the second layer 32 is sandwiched between the first layer 31 and the third layer 33. As will be discussed below, two or more of the three layers may be combined in to a single layer.

In the depicted embodiment, the second layer 32 includes intumescent material, which is herein intumescent material particles 34, filler particles 35, and a matrix 36 in which are embedded the intumescent material particles 34 and the filler particles 35. In some embodiment, the intumescent material may be an intumescent matrix. Herein, the expression “embedded” implies that the different particles (e.g., intumescent material particles 34, filler particles 35) are integrated into the matrix 36 such that these particles are wetted and surrounded by the matrix 36. In some embodiments, the filler particles 35 are omitted. The filler particles 35 are used to optimize a density and a weight of the second layer 32. The filler particles 35 may not be contributory to fire protection. In some embodiments, the filler particles 35 may be required to achieve proper rheology of the uncured matrix during its manufacturing phase. The matrix 36 therefore holds these particles. In some embodiments, fillers such as short non-combustible fibers may be used to increase a mechanical resistance of the resulting swollen structure by interlocking the carbonaceous residues. The filler particles 35 may contribute in increasing a dimension of carbonaceous residues of the intumescent layer after being exposed to the heat source. The increased dimension of these carbonaceous residues may help the first layer 31 in holding them in place. In other words, the filler particles 35 may increase a chance of survival of the carbonaceous protective material by generating bigger chunks that could be held by the compliant textile and avoid escaping through cells defined by the first layer 31 as discussed below.

The intumescent material particles 34 react to a heat source (e.g., fire) by swelling as part of their decomposition process. The second layer 32 including the intumescent material particles 34 may therefore expand thickness-wise in a direction D1 that is normal to the wall 19 on which the fire protection structure 20 is secured. It is understood that the fire protection structure 20 may be wrapped circumferentially around a component and, when exposed to a heat source, expand in a radial direction. The swelling or expansion of the second layer 32 including the intumescent material particles 34 may be triggered when a temperature in a vicinity of the fire protection structure 20 reaches a given temperature threshold. In an embodiment, this given temperature threshold is 200° C. However, other temperature thresholds, both lower and higher than 200° C. may also be possible (e.g. 150° C., 250° C., 300° C., etc.). Once this temperature threshold is exceeded, the intumescent material particles 34 start to swell and expend in the direction D1 and chemical reactions may lead to carbonization.

In a particular embodiment, the second layer 32 is made of TFP's Tecnofire™ or ElastoProxy™. The matrix 36 of the second layer 32 may include an elastomer, which may be a silicone-based elastomer. The intumescent material particles 34 may be expandable graphite or vermiculite. Vermiculite is a refractory material that may expand at a temperature of at least 1200 degrees Celsius. Alternatively, the intumescent particles 34 may include melamine, sodium silicate, any suitable material having a parasitic chemical reaction with fire. Any suitable combinations of a plurality of different kinds of intumescent particles 34 may be used. The filler particles 35 may be glass microspheres; glass hollow spheres that give volume while minimizing the added mass; viscosity modifiers, such as fume silica, to allow the material to be thixotropic (i.e., able to be sprayed on a surface and then settle without dripping); color modifier; bonding or curing agents; reinforcement; metal oxides; carbon black; other fire retardants, pigments, and so on. In some embodiment, the filler particles 35 are omitted. The filler particles 35 may include any particles having a density less than that of the matrix. The second layer 32 may be prepared by mixing the elastomer of the matrix 36 with the intumescent material particles 34 and with the filler particles 35 until a homogeneous compound is obtained. Any suitable intumescent material particles, matrix, and filler particles may be used without departing from the scope of the present disclosure. The matrix 36 may include epoxy, polyester, polyurethane, VynilEster, phenolics, any thermoset material, any thermoplastic polymers such as nylon, polypropylene, polyethylene, polyether ether ketone, polyphenylene sulfide, and polyether imide. Any suitable fire retardant matrix may be used. In some embodiments, having the intumescent material in particulate form may allow to disperse the intumescent material throughout the matrix 36 to offer a uniform fire protection; to solidly attach the particles to the matrix 36 to act as an ablative layer; and the intumescent particles may be easier to mix in the uncured matrix without interfering with the curing mechanism. Some fire retardants, such as brominated flame retardants, polybrominated diphenyl ethers, tetrabromobisphenol A, hexabromocyclododecane, organophosphate flame retardants may be used in the second layer 32.

Referring to FIGS. 2-4, the fire protection structure 20 may therefore expand from an initial thickness T0 (FIG. 4) to an expanded thickness T1 (FIG. 4) greater than the initial thickness T0. In this particular embodiment, the fire protection structure 20 was exposed to a flame for 10 minutes. When the intumescent material particles 34 reaches its expanded thickness T1, it can be extremely porous and, in consequence, fragile. However, a heat resistance through the second layer 32 may increase as its thickness increase. When it is expanded and becomes porous, the second layer 32 containing the intumescent material particles 34 may become fragile and a crumbling effect may be observed due to mechanical forces imparted on the fire protection structure 20. For instance, in some implementations in moving applications (vehicles, garments, etc), vibrations may contribute in breaking away parts of the second layer 32 containing the intumescent material particles 34 thereby impeding fire protection capabilities of the fire protection structure 20.

To at least partially alleviate the aforementioned drawbacks, the layered structure 30 includes the first layer 31 that is used for retaining the second layer 32. Namely, because of the first layer 31, pieces of the expanded second layer 32 that would otherwise fall off are retained and kept in place. This may allow the use of the intumescent material particles 34 in some applications where vibrations and other movements would typically prevent the use of said intumescent material. As one can appreciate, the layered structure 30 may remain all integral and all of its constituent layers may remain secured to one another and the intumescent material particles 34 are allowed to expand without having pieces breaking away thanks to the first layer 31 that includes a knitted structure as discussed below.

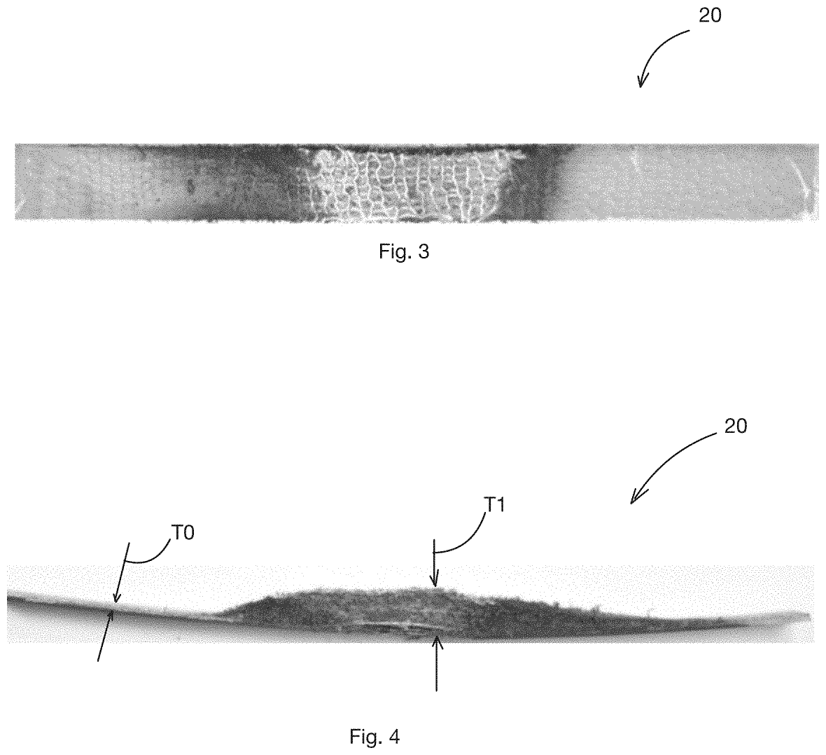

Thermal protection properties of the second layer 32 are achieved when the intumescent material particles 34 exposed to a heat source are allowed to expand. As explained above, an intumescent matrix may be used; such an intumescent matrix may expend when exposed to the heat source. Therefore, the first layer 31 has to be compliant with the expansion of the intumescent material particles 34. As shown in FIGS. 3-4, only portions of the fire protection structure 20 that are exposed to the heat source expand thickness-wise. The first layer 31 may have to allow local deformation of the second layer 32 without affecting other areas that are not exposed to the heat source.

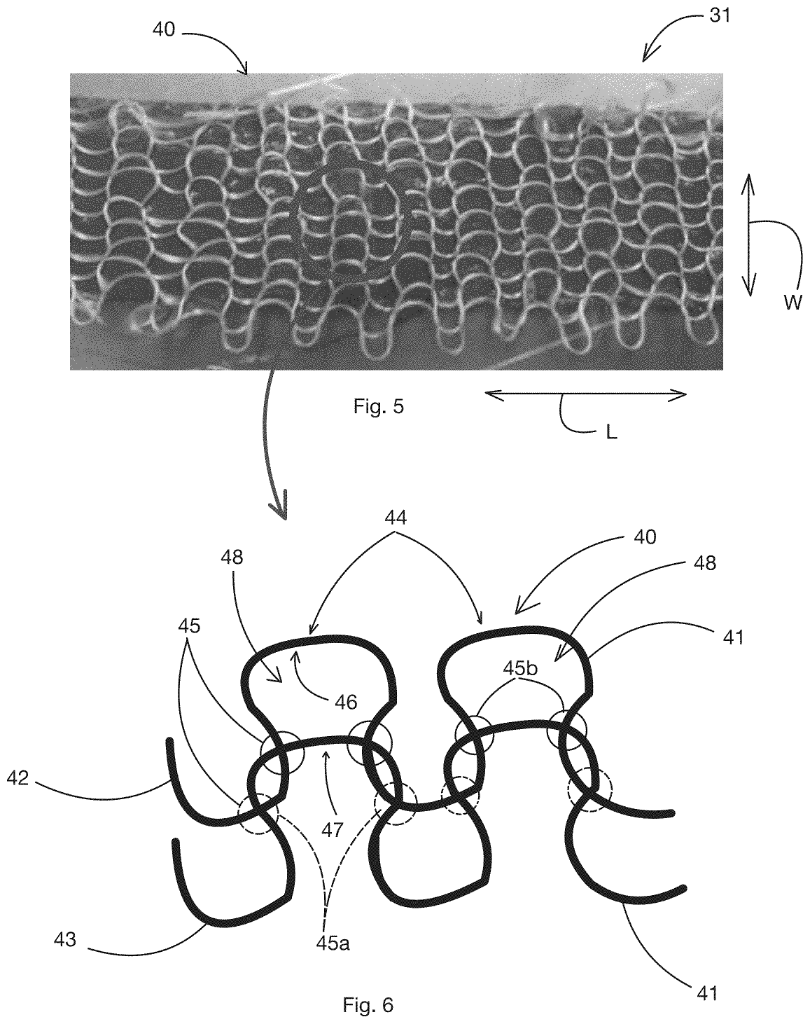

Referring now to FIGS. 5-6, an exemplary embodiment of the first layer 31 is shown enlarged. In the pictured embodiment, the first layer 31 includes a knitted structure 40 that allows local deformation of the intumescent material particles 34 and that may be locally deformed to accommodate swelling of the intumescent material particles 34 of the second layer 32 of the layered structure 30. The knitted structure 40 is used to retain the second layer 32 following its expansion when subjected to a temperature above the temperature threshold. The knitted structure 40 may be referred to as a deformable textile as explained below. Due to its compliance, the knitted structure 40 may remain intact during the deformation, or swelling, of the second layer 32 containing the intumescent material particles 34.

The knitted structure 40 includes a plurality of yarns 41 that are interconnected to one another. The knitted structure 40 is a non-woven structure. The knitted structure 40 is expandable in both of a widthwise direction W and a lengthwise direction L. The widthwise direction W and the lengthwise direction L are normal to the direction D1 of swelling and parallel to the wall 19. In some embodiments, the knitted structure 40 may extend solely in one of the widthwise direction W and the lengthwise direction L. Knitting the yarns 41 may be required to allow the first layer 31 to expand in the widthwise direction W and/or the lengthwise direction L when the yarns are, themselves, non-extensible. The knitted structure 40 may therefore be free of a yarn that extends as a straight line linearly and along either of the widthwise direction W or the lengthwise direction L as this would impede expansion of the knitted structure 40 when the yarns are substantially non-extensible. In the embodiment shown, the yarns 41 are made of a high-temperature fiber. The yarns 41 may be ceramic fibers. In a particular embodiment, the yarns 41 are 3 M's ceramic Nextel 312™ fibers. Any other suitable yarns able to withstand the temperatures the fire protection structure 20 may be exposed to are contemplated without departing from the scope of the present disclosure. In some embodiments, the yarns 41 may be made of silicon carbide fibers (e.g., Sylramic™, Nicalon™). The material of the yarns may be selected as a function of a temperature of the flame and a duration of exposure to the flame. Any suitable Nextel™ fibers of the 312, 440, 610, and 720 family may be used. If the temperature is below a certain threshold, glass fibers could be used, high-purity glass or silica fibers (e.g., Quartz fibers) may be used. The yarns 41 are deformable in flexion to allow them to be curved during a knitting process via which the yarns 41 are assembled to yield the knitted structure 40.

In the context of the present disclosure, a “woven” structure refers to a structure formed by weaving, which may be created on a loom or other suitable manufacturing system, and made of many threads woven having a warp and a weft. A woven structure may be made by interlacing two or more threads at right angles to one another. Woven structures are substantially non-extensible in the lengthwise and widthwise directions. In the context of the present disclosure, a “non-woven” structure means any structure that does not fall within the above definition of a woven structure. A “knitted” structure as used herein is therefore to be understood to be a non-woven structure.

Referring more particularly to FIG. 6, an exemplary embodiment of how the yarns 41 are knitted is described. For the sake of conciseness, only a first yarn 42 and a second yarn 43 are used for the description below, but it will be understood that this configuration may be repeated along an entirety of the knitted structure 40. It will be however appreciated that any suitable knitted structure may be used without departing from the scope of the present disclosure.

The first yarn 42 and the second yarn 43 defines a plurality of loops 44, also referred to as curved portions, or waves, along the lengthwise direction L. The loops 44 of the first yarn 42 are intersected by the loops 44 of the second yarn 43. Therefore, the first yarn 42 intersects the second yarn 43 at a plurality of intersections 45. The first yarn 42 is engaged to the second yarn 43 by their loops 44 that are interlaced with one another. That is, each of the loops 44 of the first yarn 42 is received into a respective one of the loops 44 of the second yarn 43. The second yarn 43 is disposed over the first yarn 42 at over-intersections 45a encircled with dashed lines in FIG. 6, and the second yarn 43 extends under the first yarn 42 at under-intersections 45b encircled with solid lines in FIG. 6. Stated differently, each of the first yarn 42 and the second yarn 43 defines first loops 46 and second loops 47. Each of the first loops 46 is received into a respective one of the second loops 47 to create an interlocking engagement between the first yarn 42 and the second yarn 43. Because the first yarn 42 and the second yarn 43 are not straight in the knitted structure 40, expansion of the second layer 32 is permitted by a straightening of the loops 44. This would not be possible if the first layer 31 included a woven fabric.

Referring to FIGS. 2 and 6, the knitted structure 40 defines an open-cell structure having a plurality of openings, or open cells 48. The open cells 48 are defined between the loops 44 of successive yarns 41. In some embodiments, the matrix 36 (FIG. 2) may be impregnated into the open cells 48 of the knitted structure 40 instead of having the knitted structure 40 laid against the second layer 32 of the layered structure 30. In other words, the first layer 31 and the second layer 32 may be embedded one into the other by having the knitted structure 40 embedded into the matrix 36 of the second layer 32. By being “embedded”, it is understood that the open cells 48 of the knitted structure 40 are filled with the matrix 36, and may contain some of the intumescent material particles 34, and may contain some of the filler particles 35. This may be achieved by inserting the first layer 31, the second layer 32, and, in some embodiments, the third layer 33, in a vacuum bag for curing the second layer 32 into the open cells 48 of the knitted structure 40.

The knitted structure 40 may easily deform following the swelling of the intumescent material particles 34. This change of shape can take place locally. That is, even if a small portion of the fire protection structure 20 is exposed to a heat source (e.g., open flame), the exposed area may swell freely out-of-plane in a thickness-wise direction D1 and yet stay attached and connected to a remainder of the fire protection structure 20 not exposed to the heat source. The knitted structure 40 may be sufficiently compliant to allow free, or quasi-free, deformation of the intumescent material particles 34 during its decomposition when exposed to the heat source. The knitted structure 40 may allow an increased mechanical resistance in case of load exertion (e.g., vibrations). The knitted structure 40, thanks to its textile architecture that may have draping capabilities, may enable high local deformation.

In one possible embodiment, the knitted structure as defined herein may comprise a three-dimensional architecture with a high-compressibility ratio. Different fibers and/or filaments types could be used if the capability to deform remains untainted.

Referring back to FIG. 2, the third layer 33 may include a binding or adhesive agent for securing the fire protection structure 20 to the wall 19. The third layer 33 may include a putty, a film, a liquid, a pressure-sensitive tape, or any other suitable means used for attaching the fire protection structure 20 to the wall or the other component. In some alternate embodiments, mechanical fasteners may be used. That is, the third layer 33 may include hook-and-loops fasteners, hooks, clamps, cleats, and any other suitable fastening means for securing the fire protection structure 20 to the wall or to the other component without departing from the scope of the present disclosure.

The first layer 31, the second layer 32, and the third layer 33 of the layered structure 30 may be arranged/swapped as required. The first layer 31 including the deformable textile (e.g., knitted structure 40) may be integrated within the second layer 32 as discussed above or superficially disposed atop the second layer 32 including the intumescent material particles 34. Several textile layer can be used and spread throughout the thickness. A connecting binder can be placed either between the protected surface and the protection or can be integrated within the protection. That is, the third layer 33 may be integrated into the matrix 36 of the second layer 32 such that the three layers are all embedded within one another, in a single layer. For instance, the second layer 32 including the intumescent material particles 34 may further include an adhesive, such as epoxy, that may be flown throughout the fibrous body and into the open cells 48 of the knitted structure 40, joining the three layers in a single layer including the knitted structure 40, the adhesive, and the intumescent material particles 34 all extending from the first side 21 to the second side 22 of the fire protection structure 20. In other words, at least a portion of the second layer 32 is disposed between the wall 19 and the knitted structure 40.

Any suitable compliant textile structure may be used without departing from the scope of the present disclosure. This compliant textile structure may be, for instance, an expandable three dimensional textile. In other words, the first layer may include a three-dimensional woven structure including a first textile extending in a widthwise and lengthwise directions; a second textile extending in the widthwise and lengthwise directions; and yarns connecting the first textile to the second textile, the yarns extending in a thickness-wise direction from the first textile to the second textile. The yarns between the first and second textiles may act as spring to bias the two textiles away from one another. The three-dimensional woven structure may be compressed to decrease a distance between the first textile and the second textile. This compressed three-dimensional woven structure may be embedded into the matrix as described above. When exposed to a heat source, the intumescent material expands thereby increasing locally a distance between the first and second textiles.

The fire protection structure 20 may be customized according to the weight, volume and other functional requirements. The fire protection structure 20 may be provided in sheets and cut to accommodate the desired geometry (e.g., curved wall, pipe, etc). The fire protection structure 20 may be applied/cured on site for local consolidation.

When the intumescent material 34 has expanded from its initial thickness T0, to its expanded thickness T1, the knitted structure 40 may reinforce the second layer 32 and may help in preventing the intumescent material particles 34 that have expanded from falling off. The knitted structure 40 may act similarly as reinforcing bars in concrete. In some cases, bonding methods are incompatible with silicon-based elastomers. Therefore, mechanical attachment may be required using silicone-based elastomer for the matrix 36 of the second layer 32.

The disclosed fire protection structure 20 may offer a lighter alternatives to existing gas turbine engine fire walls.

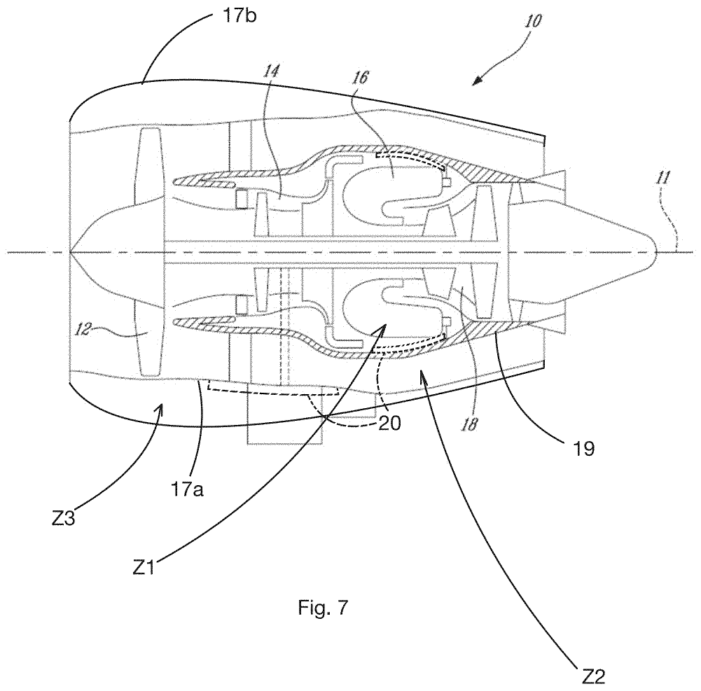

FIG. 7 illustrates schematically a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The fan 12, the compressor section 14, and the turbine section 18 are rotatable about a central axis 11 of the gas turbine engine 10.

Components of the gas turbine engine 10, for instance, the combustor 16, may become very hot during use. It may therefore be required to protect a fire zone Z1, containing the combustor 16, from a non-fire zone Z2. In the embodiment shown, a fire protection structure 20 is used to isolate the fire zone Z1 from the non-fire zone Z2.

The gas turbine engine 10 may include a wall 19 separating the fire zone Z1 from the non-fire zone Z2. The fire protection structure 20 described above may be affixed to the wall 19. In the embodiment shown, the engine 10 includes an outer casing 17a. A nacelle 17b is secured to the outer casing 17a to improve an aerodynamic efficiency of the engine 10. A space between the outer casing 17a and the nacelle 17b may be a second fire zone Z3 since this space may be exposed to potential leaks because many tubes and other fluid conduits may be located in this space. The fire protection structure 20 may be applied against an outer side of the outer casing 17a (as shown in dashed lines in FIG. 7) to protect the non-fire zone Z2 in case of a fire.

The fire proof structure 20 may be used in nacelles, bypass ducts, fan cases and thrust reversers of aircraft engines. It may also be used within the nacelle to protect engine mounts, accessory gearbox, fuel-oil heat exchanger and oil tanks of aircraft engines. The fire protection structure 20 may be used throughout an aircraft where fire protection may be required, such as in flight controls, flight structure, cargo compartments, landing gear compartments, fuel tanks, electrical systems and components and so on.

In some embodiments, some aircraft and aircraft engine structural components may be required to be fireproof, that is, they may have to be able to withstand an average flame temperature of 1100 degrees Celsius for at least 15 minutes.

The embodiments described in this document provide non-limiting examples of possible implementations of the present technology. Upon review of the present disclosure, a person of ordinary skill in the art will recognize that changes may be made to the embodiments described herein without departing from the scope of the present technology. Although the disclosed fire protection structure 20 has been described for use with a gas turbine engine, it may be used in a house against domestic fire; it may be used to fight forest fires; and it may be used in industries (e.g., oil industry). Yet further modifications could be implemented by a person of ordinary skill in the art in view of the present disclosure, which modifications would be within the scope of the present technology.

1. A fire protection structure to be affixed to a substrate adapted to be exposed to a heat source, comprising:
an expandable layer containing an intumescent material expandable when exposed to the heat source, the expandable layer expandable, when exposed to a temperature above a temperature threshold generated by the heat source, from a first thickness to a second thickness greater than the first thickness; and
a compliant textile structure retaining the expandable layer, at least a portion of the expandable layer disposed relative to the compliant textile structure such that the portion of the expandable layer is disposed between the substrate and the compliant textile structure when the fire protection structure is attached to the substrate, the compliant textile structure deformable with expansion of the expandable layer from the first thickness to the second thickness.

2. The fire protection structure of claim 1, wherein the compliant textile structure is a knitted structure extensible both in a widthwise direction and a lengthwise direction, both of the widthwise direction and the lengthwise direction parallel to the substrate.

3. The fire protection structure of claim 1, wherein the expandable layer includes a matrix, the intumescent material including intumescent particles embedded in the matrix.

4. The fire protection structure of claim 3, wherein the expandable layer includes filler particles embedded in the matrix.

5. The fire protection structure of claim 3, wherein the intumescent particles are expandable graphite particles, vermiculite, melamine, and/or sodium silicate, and wherein the matrix includes an elastomer.

6. The fire protection structure of claim 1, wherein the expandable layer and the compliant textile structure are embedded into one another.

7. The fire protection structure of claim 6, wherein the compliant textile structure is a knitted structure, the knitted structure including yarns knitted together, the knitted structure having open cells between the yarns, the open cells filled with the expandable layer.

8. The fire protection structure of claim 1, wherein the compliant textile structure is a knitted structure, the expandable layer and the knitted structure are each a respective layer of a layered structure, the expandable layer sandwiched between the knitted structure and the substrate.

9. The fire protection structure of claim 1, wherein compliant textile structure is a knitted structure including a first yarn and a second yarn, the first yarn defining successive first loops, the second yarn defining successive second loops, each of the first loops received in a respective one of the second loops.

10. The fire protection structure of claim 1, comprising a fastening layer connected to the expandable layer for securing the fire protection structure to the substrate, the fastening layer including an adhesive or mechanical fasteners.

11. A gas turbine engine, comprising:
a first zone and a second zone;
a wall between the first zone and the second zone; and
a fire protection structure affixed to the wall, the fire protection structure including:
an expandable layer containing an intumescent material expandable when exposed to a heat source, the expandable layer expandable, when exposed to a temperature above a temperature threshold generated by the heat source, in a direction normal to the wall from a first thickness to a second thickness greater than the first thickness, and
a compliant textile structure retaining the expandable layer, at least a portion of the expandable layer disposed between the wall and the compliant textile structure, the compliant textile structure deformable with expansion of the expandable layer from the first thickness to the second thickness.

12. The gas turbine engine of claim 11, wherein the compliant textile structure is a knitted structure extensible both in a widthwise direction and a lengthwise direction, both of the widthwise direction and the lengthwise direction parallel to the wall.

13. The gas turbine engine of claim 11, wherein the expandable layer includes a matrix, the intumescent material including intumescent particles embedded in the matrix.

14. The gas turbine engine of claim 13, wherein the expandable layer includes filler particles embedded in the matrix.

15. The gas turbine engine of claim 13, wherein the intumescent particles are expandable graphite particles, vermiculite, melamine, and/or sodium silicate, and wherein the matrix includes an elastomer.

16. The gas turbine engine of claim 11, wherein the expandable layer and the compliant textile structure are embedded into one another.

17. The gas turbine engine of claim 16, wherein the compliant textile structure is a knitted structure, the knitted structure including yarns knitted together, the knitted structure having open cells between the yarns, the open cells filled with the expandable layer.

18. The gas turbine engine of claim 11, wherein the compliant textile structure is a knitted structure, the expandable layer and the knitted structure are each a respective layer of a layered structure, the expandable layer sandwiched between the knitted structure and the wall.

19. The gas turbine engine of claim 11, wherein the compliant textile structure is a knitted structure including a first yarn and a second yarn, the first yarn defining successive first loops, the second yarn defining successive second loops, each of the first loops received in a respective one of the second loops.

20. The gas turbine engine of claim 19, wherein the yarns are ceramic yarns.
